(19) United States
(12) Patent Application Publication
(10) Pub. No.: US 2013/0295234 A1
(43) Pub. Date: Nov. 7, 2013

(54) MACARONI AND CHEESE SANDWICH

(71) Applicant: Christopher Patrick Culp, Cumming, GA (US)

(72) Inventor: Christopher Patrick Culp, Cumming, GA (US)

(73) Assignee: Six Continents Hotels, Inc., Atlanta, GA (US)

(21) Appl. No.: 13/462,589

(22) Filed: May 2, 2012

(51) Int. Cl. A21D 13/00; A23C 19/00; A23L 1/01; A23L 1/16

(52) U.S. Cl. 426/94; 426/275

(57) ABSTRACT

A macaroni and cheese sandwich. The sandwich includes a top slice of bread, a bottom slice of bread, and macaroni and cheese between the top slice of bread and the bottom slice of bread. The ingredients are toasted in and impressed by a waffle iron to create waffle patterns on the outside of the two slices of bread. Cheese slices can be added between the bread slices and the macaroni and cheese to add cheese flavor and to bond the macaroni and cheese to the bread during toasting.

### BACKGROUND

Hotels are establishments that provide lodging, meals, entertainment, and various personal services for the public. Many modern hotels include full service restaurants, swimming pools, fitness centers, business centers, childcare, conference facilities, and social function services.

Most hotels have a restaurant. Hotel restaurants and restaurants that are not associated with hotels are constantly looking for unique and tasty food service items, either for use as entrées or appetizers. Very often, the emphasis is on inexpensive, filling food.

One popular food item is a sandwich. A sandwich typically consists of two or more slices of bread with one or more fillings between them. A sandwich can be handheld and is portable, and is easy for children and people of limited ambulation to eat.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments herein are directed to a sandwich having macaroni and cheese between two slices of bread. The sandwich is cooked in a waffle iron to toast the bread and create a waffle pattern on the outer surfaces of the bread.

In embodiments, one or more slices of cheese may be added to the sandwich. For example, a slice of cheese may be added between the top slice of bread and the macaroni and cheese, and a second slice of cheese may be added between the bottom slice of bread and the macaroni and cheese. In embodiments, the cheese melts as part of the toasting process in the waffle iron.

In additional embodiments, a method of making a sandwich is provided. The method includes stacking ingredients for the sandwich, the ingredients including a top slice of bread, a bottom slice of bread, and macaroni and cheese between the top slice of bread and the bottom slice of bread. The stacked ingredients are toasted in a waffle iron so as to form a toasted waffle pattern on the top of the top slice of bread and the bottom of the bottom of slice of bread. The ingredients may also include a slice of cheese between the top slice of bread and the macaroni and cheese. If so, then the toasting can occur until the slice of cheese is at least partially melted. In addition, another slice of cheese may be included between the bottom slice of bread of the macaroni and cheese, with the toasting occurring until the bottom slice of cheese is at least partially melted.

To aid in removal of the sandwich from the waffle iron, a nonstick spray may be sprayed on the slices of bread or the waffle iron prior to toasting.

For a fuller understanding of the nature and advantages of the present invention, reference should be made to the ensuing detailed description and accompanying drawings.

### BRIEF DESCRIPTION OF THE DRAWINGS

FIG. 1 is an exploded perspective view of ingredients for a sandwich in accordance with embodiments;

FIG. 2 is a perspective view of a waffle iron with the ingredients of FIG. 1 installed thereon; and

FIG. 3 is a perspective view of a sandwich cooked by toasting the ingredients in the waffle iron of FIG. 2 in accordance with embodiments.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details.

Furthermore, well-known features may be omitted or simplified in order not to obscure the embodiment being described.

Embodiments herein are directed to a sandwich having macaroni and cheese between two slices of bread. The sandwich is toasted in a waffle iron so as to toast the bread and to provide a waffle iron pattern on the outer surface of the bread. In embodiments, one or more slices of cheese may be added to the sandwich prior to toasting so that additional cheese flavor, and calories are added to the sandwich, and to enhance the cheese flavor of the sandwich.

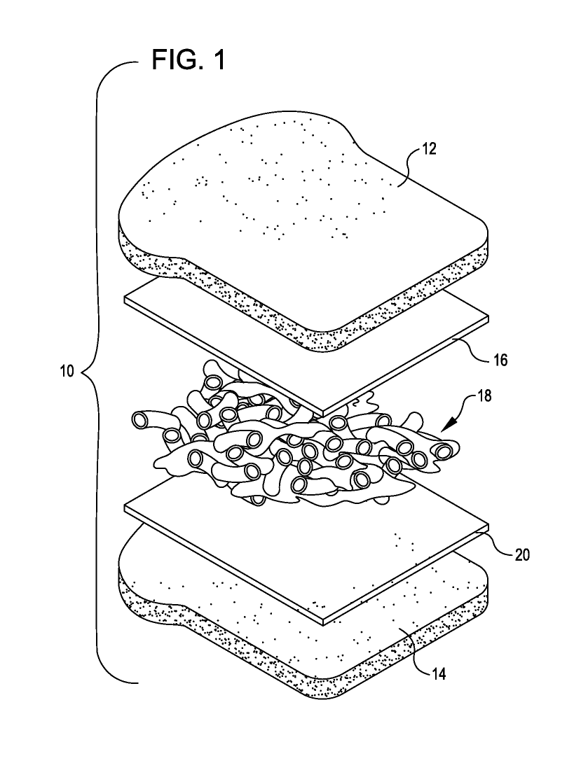

FIG. 1 is an exploded perspective view of ingredients 10 for a sandwich in accordance with embodiments. The sandwich ingredients 10 include a top slice of bread 12 and a bottom slice of bread 14. These slices of bread may be any conventional bread, but embodiments are Texas toast-style bread. Texas toast is a type of packaged bread, which is pre-sliced at double the typical thickness of most pre-sliced breads. In addition, as used herein, “slice” can mean any form of bread that may be used to assemble the ingredients 10. Adjacent to the slices of bread 12, 14 and interior to the sandwich are provided slices of cheese 16, 20. A first slice of cheese 16 is positioned immediately below the top slice of bread 12. The second slice of cheese 20 is positioned immediately above the bottom slice of bread 14. These slices of cheese may be any type of cheese desired, but in embodiments are a sharp cheddar cheese, for example, a one ounce slice.

Between the two slices of cheese 16, 20, is positioned macaroni and cheese 18. Macaroni and cheese is a dish consisting of elbow macaroni and cheese sauce. Traditionally prepared as a casserole, macaroni and cheese is now often prepared on a stove-top or in a microwave using a packaged food mix. The dish is typically a noodle gratin with macaroni pasta in place of potatoes. In embodiments, the macaroni and cheese 18 may be any noodle and cheese mixture. The macaroni and cheese 18 may be any style, including homemade, or a packaged variety. In embodiments, the macaroni and cheese 18 is a pre-frozen macaroni and cheese. Applicants have found that Kraft brand macaroni and cheese pre-frozen 7 oz. packages work well in formation of their sandwiches. The 7 oz. packages are divided in half, with 3.5 oz. utilized on individual sandwiches. Although this pre-frozen variety is described in embodiments, other macaroni and cheese products could be used.

The macaroni and cheese 18 is prepared prior to inserting it into the sandwich ingredient stack. Preparation may involve heating prepackaged macaroni and cheese, allowing a frozen package to thaw, or cooking the macaroni and cheese on a stovetop or in a microwave, as non-limiting examples.

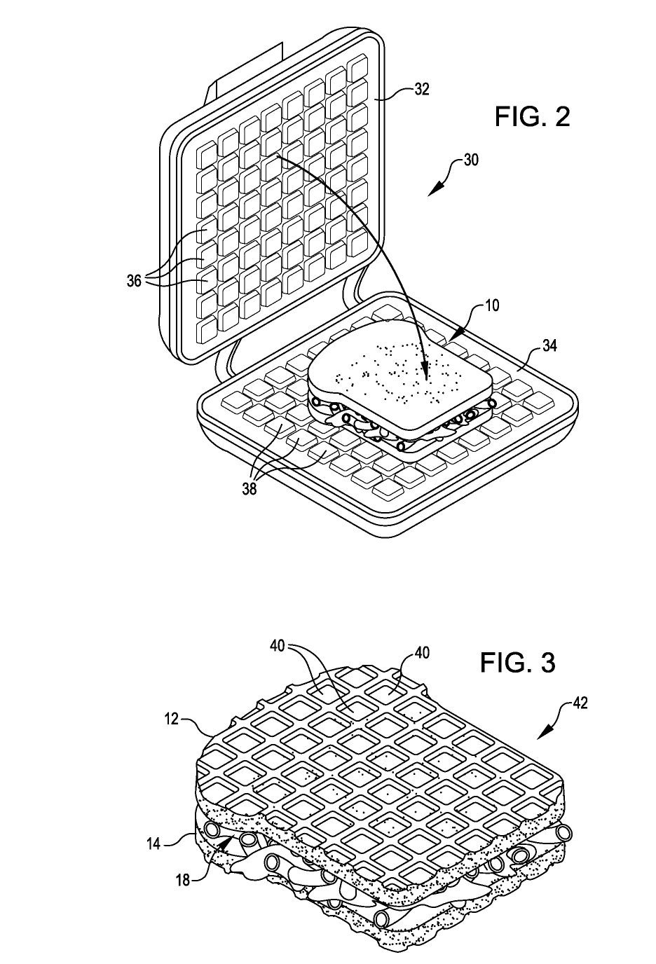

The assembled stack of sandwich ingredients 10 in FIG. 1 is then placed in a waffle iron, for example the waffle iron 30 in FIG. 2, for toasting. If desired, the outer surface of the top and bottom slices of bread 12, 14 can be spread with a lubricant, such as butter or a nonstick baking spray, or maybe coated with another suitable nonstick agent so as to prevent or limit sticking of the bread slices 12, 14 to the waffle iron 30 during toasting.

The waffle iron 30 shown in the drawings is a conventional Belgium waffle iron model, having a top plate 32, a bottom plate 34, a honeycomb top pattern 36 on the top plate and a honeycomb bottom pattern 38 on the bottom plate. The waffle iron 30 shown in the figure has a square cross-section, but round or other shapes could be used. In addition, other waffle irons may be used, but in embodiments, a Belgian waffle iron is utilized. A Belgian waffle iron provides deep, distinct indentations when toasting. Waffle irons having different patterns could be used. In embodiments, the waffle iron impresses a pattern into the surfaces of the bread slices 12, 14 during the toasting process.

To toast the sandwich ingredients, the waffle iron 30 is closed, allowing the top plate 32 to come into contact with the top of the top slice of bread 12. In embodiments, the weight of the top plate 32 for the waffle iron 30 is sufficient to hold the ingredients in place and provide sufficient pressure to impress a honeycomb pattern into the bread slices 12, 14 during the cooking process.

The sandwich ingredients 10 are cooked for a sufficient amount of time to at least partially toast the bread slices 12, 14 and to impress the waffle pattern 40 shown in FIG. 3 in the outer surfaces of the bread for the toasted sandwich 42. In addition, in embodiments, the cooking process occurs for sufficient amount of time to melt, or at least partially melt, the cheese slices 16, 20. In this manner, the cheese is no longer hard and is easier to eat. In addition, the cheese slices 16, 20 can act as bonding agents to bond the bread slices 12, 14 to the macaroni and cheese 18.

In embodiments, as described above, the macaroni and cheese 18 is cooked prior to the toasting process described above. However, part of the cooking, heating, or thawing process for the macaroni and cheese may occur as part of the toasting process that occurs in the waffle iron 30.

The sandwich 42 shown in FIG. 3 is ready for serving to patrons. It may be cut into quarters or halves or may be served as a whole. The extra cheese slices 16, 20 provide extra cheese flavor and filling for the sandwich. The waffle pattern 40 provides an aesthetically pleasing sandwich that can serve as an interesting curiosity for children or adult patrons. The final product includes toasted top and bottom slices of bread 12, 14, which is often preferred by patrons in their sandwiches. In addition, the cheese slices 16, 20, which are fully or partially melted, add flavor to and calories to the sandwich 42.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A sandwich, comprising:
a top slice of bread having a waffle pattern impressed on a top surface;
a bottom slice of bread having a waffle pattern impressed on a bottom surface; and
macaroni and cheese between the top slice of bread and the bottom slice of bread.

2. The sandwich of claim 1, further comprising a slice of at least partially melted cheese between the top slice of bread and the macaroni and cheese.

3. The sandwich of claim 2, further comprising a slice of at least partially melted cheese between the bottom slice of bread and the macaroni and cheese.

4. The sandwich of claim 3, wherein the top slice of bread and the bottom slice of bread each comprise Texas toast type of bread slices.

5. The sandwich of claim 1, further comprising a slice of at least partially melted cheese between the bottom slice of bread and the macaroni and cheese.

6. The sandwich of claim 1, wherein the top slice of bread and the bottom slice of bread each comprise Texas toast type of bread slices.

7. A method of making a sandwich, comprising:
stacking ingredients for the sandwich, the ingredients comprising:
a top slice of bread;
a bottom slice of bread; and
macaroni and cheese between the top slice of bread and the bottom slice of bread; and
toasting the stacked ingredients in a waffle iron and impressing a waffle pattern into the bread slices so as to form a waffle pattern on a top of the top slice of bread and a bottom of the bottom slice of bread.

8. The sandwich of claim 7, wherein the ingredients further comprise a slice of cheese between the top slice of bread and the macaroni and cheese, and wherein toasting comprises toasting until the slice of cheese at least partially melts.

9. The sandwich of claim 8, wherein the ingredients further comprise a slice of cheese between the bottom slice of bread and the macaroni and cheese, and wherein toasting comprises toasting until the slice of cheese at least partially melts.

10. The sandwich of claim 7, wherein the ingredients further comprise a slice of cheese between the bottom slice of bread and the macaroni and cheese, and wherein toasting comprises toasting until the slice of cheese at least partially melts.

11. The sandwich of claim 7, further comprising spraying at least one of the slices of the bread or the waffle iron with a nonstick spray before toasting.
